(19) United States
(12) Patent Application Publication
(10) Pub. No.: US 2004/0227067 A1
(43) Pub. Date: Nov. 18, 2004

(54) Phase alignment for angular and linear encoders and an encoder

(76) Inventor: Anton Rodi, Leimen (DE)

Correspondence Address: LERNER AND GREENBERG, PA, P O BOX 2480, HOLLYWOOD, FL, 33022-2480, US

(21) Appl. No.: 10/827,630

(22) Filed: Apr. 19, 2004

(30) Foreign Application Priority Data
May 15, 2003 (DE) 103 22 130.1

(51) Int. Cl. G01D 5/34; G01B 11/14

(52) U.S. Cl. 250/231.14; 250/231.13

(57) ABSTRACT

Angular and linear encoders have incremental scale divisions. An encoder has sensors in a sensor configuration for creating signals relative to a path traveled that are displaced in a measuring direction. By displacing the sensor axis relative to the measuring axis the phase deviation between the scale division and the sensor distance is eliminated allowing efficient production of the encoder components.

### BACKGROUND OF THE INVENTION

Field of the Invention

Angular and linear encoders currently employ optical, magnetic and other physical principles of measurement and most are configured with incremental scales. In order to increase the resolution of the measuring systems the principle has also been adopted of always configuring the incremental segments in combination with a sensor in such a way that a constant analog signal proportional to the linear segment is produced whose amplitude is then more finely resolved via AD converters or so-called interpolators. The production of sine wave amplitudes is preferred which allow particularly simple determination of the direction of movement in a sensor configuration with for example two sensors displaced in the measuring direction. In addition it also allows the determination of the absolute positions within the segment via the relationships of trigonometric functions, e.g. arc tan formation. However, in order to record these absolute values, it is important to dispose the sensors for creating two signal sequences as precisely as possible at distances of ½+/−¼ of the division period within one or several magnetic periods to get sine/cos signals. The signal sequences that are thus shifted by 90° (or 270°) are particularly easy to evaluate using the usual methods.

The increasingly finer resolution and greater precision required of such angular and linear encoders, however, puts great demands on precisely maintaining the divisions of the scales. In this respect it is considerably simpler from a manufacturing point of view to produce identical segments than to maintain exact pre-determined absolute segment dimensions during the production process. This is just as important, however, since the sensors are also positioned according to the pre-determined absolute scale and must then be aligned exactly in the measuring system. This requirement results in a considerable amount of adjustment as well as manufacturing costs and leads to undesirable phase errors if the alignment is not correct. The phase deviation in the signal sequences of 90° leads not only to problems in evaluation, but the errors also directly affect the deviation in linearity or absolute value of the measured values.

### SUMMARY OF THE INVENTION

It is accordingly an object of the invention to provide a phase alignment for angular and linear encoders and an encoder that overcomes the above-mentioned disadvantages of the prior art devices and methods of this general type. The invention is configured to provide a solution for achieving the desired precision in processing measured values by exact adjustment of the phase alignment with the lowest possible adjustment and production costs.

With the foregoing and other objects in view there is provided, in accordance with the invention, an encoder. The encoder contains a measuring unit having incremental scale divisions and at least one sensor configuration. The sensor configuration has at least two sensors displaced in a measuring direction and provides signals relating to a path traveled within a segment. Effective distances of the sensor configuration containing the sensors projected onto a measuring axis in the measuring direction are altered by displacing the sensor axis relative to the measuring axis.

In accordance with an added feature of the invention, the sensor axis is rotated relative to the measuring axis. Alternatively, the sensor axis is tilted relative to the measuring axis. Additionally, the encoder containing the sensor configuration can be rotated and/or tilted relative to the measuring direction or the sensor configuration is rotated and/or titled within the encoder.

In accordance with another feature of the invention, a carrier substrate is provided. The sensors are disposed on the carrier substrate and a distance between the at least two sensors on the carrier substrate is greater than or equal to T (n+½±¼), where T is an incremental measuring division and n a total number of the scale divisions in the measuring unit effectively covered by the sensors.

With the foregoing and other objects in view there is provided, in accordance with the invention, a process for an encoder that evaluates incremental scale configurations using sensors displaced in a measuring direction. The process includes displacing a sensor axis relative to a measuring axis.

The description of the figures below, using a magnetic measuring principle as an example, provides a more detailed explanation as well as a description of the invention, although the relationships described are completely independent of the physical principles of measurement that are also explicitly included in the application for protection.

Other features which are considered as characteristic for the invention are set forth in the appended claims.

Although the invention is illustrated and described herein as embodied in a phase alignment for angular and linear encoders and an encoder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a magnetic scale with an encoder;

FIG. 2 is a diagrammatic, top plan view of the magnetic scale with the encoder;

FIG. 3 is a diagrammatic, side view of a carrier substrate;

FIG. 4 is a diagrammatic, top plan view of sensors on the carrier substrate; and

FIG. 5 is a graph of a sensor configuration in a reference system.

### DESCRIPTION OF THE PREFERRED EMBODIMENTS

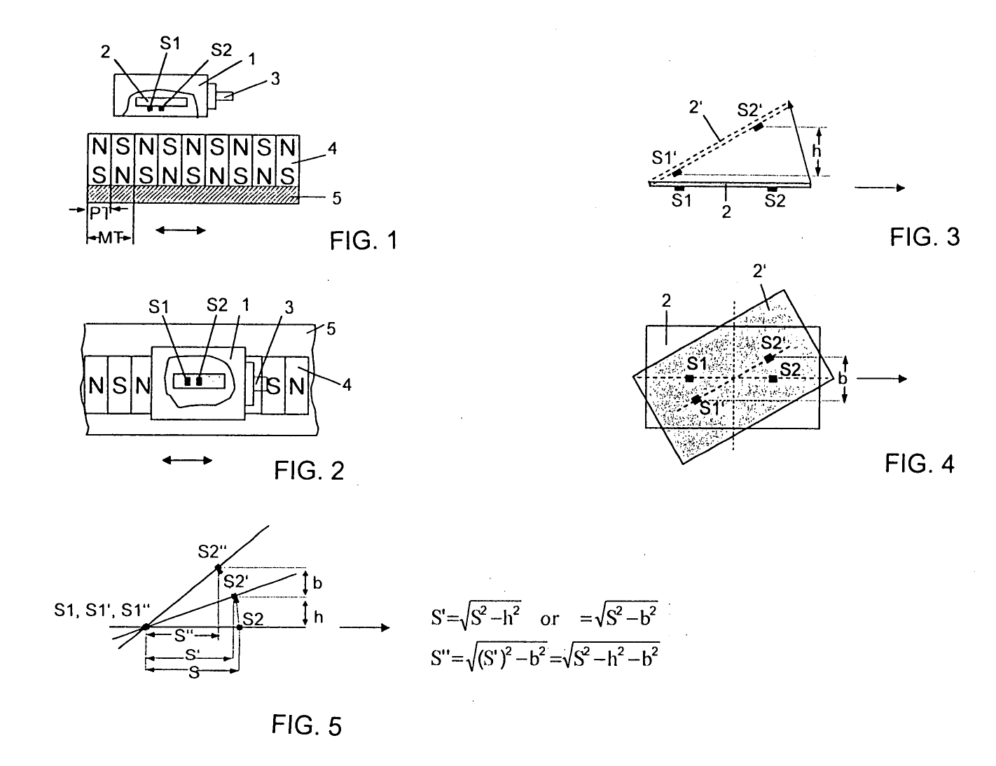

Referring now to the figures of the drawing in detail and first, particularly, to FIG. 1 thereof, there is shown a scale with alternate N/S or S/N magnetic pole divisions 4, which are disposed on a magnetically conductive carrier strip 5 and attached with, for example, an adhesive compound. The magnetic fields run symmetrically from the N to the S pole across practically the whole width of the scale. Magnetic induction decreases with increasing distance from the surface of the scale. A simplified rule of thumb for magnetic measuring systems is that the best point to record measurements is at a distance of approximately ½ MT. At approximately ±25% of this point it is also still possible to achieve very strong sine waves of the induction in amplitude and phase position with respect to the measuring direction within the angle or linear magnet division. Disposed above is an encoder 1 with a cable output 3, which includes a signal recorder and a measured value processor and feeds measured values to a non-illustrated external control or exchanges data with it and from which, for example, it also receives its main voltage supply. The exchange of measured data may be via a great variety of cables (copper, fiber optic, etc.) as well as wirelessly, for instance, by radio. The sectional view shows two sensors S1, S2 a distance apart on a carrier substrate 2 parallel to the scale along a measuring axis of the measuring direction. The sensors S1, S2 may be based on any type of magnetic sensitive principles of operation, e.g. the Hall or magneto-resistive effect. Hall sensors are used as the example below and their phase relationship described. Since Hall sensors record magnetic induction B with the correct sign, a magnetic division (MT) for a 360° sine wave is produced across two pole divisions (PT) N/S and S/N. Therefore, a 90° phase relationship of the two sensors covers a distance of ¼ of the magnet division MT (two pole divisions) or ½ of the pole division PT (N/S or S/N). Assuming a pole division PT of 1 mm and an interpolation of 11 bits (2000 times), this will produce a linear resolution within the magnet division of 1 μm. This already makes great demands on the reproducible production of such magnetic pole divisions for scales that are magnetized with a consecutive change in polarity of N/S or S/N. The magnetizable base material is almost always made of plastic (polymer) with embedded barium or strontium ferrites, having at 12 μm/m ° K. approximately 30 . . . 50 times the coefficient of expansion of steel. It is therefore sensible to apply the strip of base material to the desired carrier material in advance and secure it with, for instance, adhesive compound, before it is precisely magnetized. It is not only the diverse range of desired carrier materials as well as the various thicknesses of magnetizable base materials which make it difficult to produce scales with the correct alignment while maintaining the temperature as constant as possible; the choice of adhesive compound (hard or soft adhesive, point of application etc.) is ultimately also important for the accuracy as well as reproducibility of the magnetic divisions in later use. In addition to this there is also the distance between the two sensors S1, S2 which is adjusted to the scale division, must relate exactly to the magnet division and has a tolerance smaller than the desired measuring resolution of, for instance, 1 μm. It is obvious that the production process both for the measuring position of the sensors as well as the scales must concentrate primarily on reproducing a constant division distance, in order to fulfill the requirement for cost-effective manufacturing precision. The object therefore remains of overcoming variations in the absolute dimensions of the magnet segments and sensor distances, if a measuring system with the accuracy of the order of magnitude of the resolution is to be achieved. Precision machines, in which this type of measuring system is used, also demand accuracy that is in the mid range of the measuring systems. The temperatures at such a range of operation, for example in offset printing presses, are 10 . . . 15° K. higher than room temperature and make the adjustment of the adhered magnet strip material and the sensor configuration in the system even more problematic from the point of view of phase alignment. Alignment is made all the more difficult if the sensor configurations are integrated in semiconductors on a chip with silicon as the carrier substrate. An accuracy of well below a micrometer is guaranteed for the distances between the sensors but the difficulty comes with the alignment of the phase position now being transferred solely to the production process for manufacturing the scale. It is obvious that absolute variations in the phase relationship between the scale and sensor make the alignment and manufacturing process more expensive and lead to continual variations in the measurement of linearity and absolute measured values. It is clear in the above-mentioned example that the manufacture of more reproducible incremental divisions, e.g. within 1 μm of each other, is achievable, but the absolute variation caused by the separate manufacturing processes for the scale and sensor configuration as well as during operation of the measuring system lead to greater phase deviations of approximately one order of magnitude (up to 10 μm). This is undesirable, however, and leads to costly processes in configuring and manufacturing the components of the measuring system.

The construction of the sensor configuration according to the invention eliminates as far as possible the disadvantage of phase deviation between the scale division and the effective sensor distance and enables the efficient production of the encoder and the scale.

FIG. 2 uses the same encoder 1 as in FIG. 1, shown aligned in the measuring direction and in top view to the scale 4 on the scale carrier 5. The drawing shows a top view of the same sensors S1, S2 as in FIG. 1 as well as shifted by ¼ MT or ½ PT in its phase relationship to the scale in the measuring axis of the measuring direction. The magnetic fields flow symmetrically in the measuring direction across the width of the scale from N to S so that the sensor axis may also be displaced in parallel to the central axis of the scale. In contrast to the distance of the sensor axis S1, S2 from the scale in FIG. 1, in which the magnetic induction changes, at a selected distance of the sensor axis the magnetic induction remains practically constant across the width of the plane of the scale.

The relative movement between the scale 4, 5 and the encoder 1 covers a velocity range of 0 to approximately 10 m/sec so that finer resolutions make very high demands on measured signal processing, and limit frequencies of the digital logic currently reach 30 MHz to 50 MHz. When measuring at such speeds it is desirable for the measured signals to have as far as possible the same amplitude and phase and therefore the encoder must move very precisely over the whole measuring distance with respect to its height above and side displacement to the scale. Even more demanding are rotary encoders where the distance of the encoder to the measuring disk also affects the effective magnet division MT and hence the phase relationship of the sensors S1, S2. There is the added complication of the range of the measuring disk accurately matching the whole number magnet division. It is clear from all of this how important it is to carry out subsequent alignment or adjustment of the phase relationship of sensor signals S1, S2, as is guaranteed by the configuration according to the invention.

FIG. 3 shows an enlarged side view of the sensor configuration S1, S2 on the carrier substrate 2. The carrier substrate 2 for the sensors may be for example a circuit board, film, ceramic plate or a silicon chip. There is increasing use of integrated circuits containing for example Hall sensors with signal and measured value processor embedded on a silicon chip. The sensors S1, S2 may also be displaced across several magnet divisions in multiple configurations to create at least two signal sequences as required. Common to all the sensors is the fact that the sensor configuration is located along the sensor axis and is at an effective position relative to the measuring axis given by the scale with its magnet divisions in the measuring direction. FIG. 3 shows the sensor axis on the carrier substrate 2 given by sensors S1 to S2 in a parallel starting position at a distance from the surface of the scale and hence the measuring direction (arrowed) in accordance with the measuring axis. The distance between S1 and S2 must be exactly right relative to the magnet division of the scale. For Hall sensors, for example, the sensor distance within a magnet division MT must be exactly MT (½±¼). For most MR sensors the distance PT (½±¼) is only half as great since the sinusoidal oscillation is given by the square of the magnetic induction. If the sensor configuration stretches across several n whole magnet divisions MT or pole divisions PT, the above-mentioned sensor distances are given by MT (n+½±¼) or PT (n+½±¼). Generally speaking, the sensor distance is given by the incremental measuring division T of the scale in the measuring device as T (n+½±¼). Now if the scale division T is smaller than that originally selected or produced for the sensor configuration, any deficiencies can be eliminated according to the invention. This is also the case if the sensor configuration is configured to have a correspondingly larger distance between the sensors S1, S2 for the incremental divisions compared to the scale or disk. FIG. 3 shows a possible solution whereby the sensor axis with the carrier substrate 2′ is tilted by height h from the measuring axis in the measuring direction. The effective distance of the sensor configuration with sensors S1′, S2′ is given by vertical projection onto the measuring axis (arrow).

Therefore, the effective distance between sensors S1′ and S2′ in the measuring device with respect to the measuring axis in the measuring direction is thus smaller than the distance actually on the carrier substrate 2′. For magnetic scales the displacement given by inclining at height h can be adjusted by up to approximately ±25% of the optimum height of approximately one pole division. Hence for a given pole division of 1 mm it would be possible to have a tilt h of the sensor axis of up to approximately 0.5 mm in total which means up to approximately 15% reduction in the alignment of the incremental measuring division T between the scale and the encoder without any effect on the operation of the measuring device.

FIG. 4 shows a top view of the carrier substrate 2 with the sensors S1, S2, whereby the sensor axis produced by sensors S1 to S2 follows the same line as the measuring axis in the measuring direction (arrow). Therefore, the effective distance of sensors S1, S2 is identical to that on the carrier substrate. This also applies to FIG. 3 as long as the sensor axis follows the same line as the measuring axis in the measuring direction.

FIG. 4 shows another possible displacement of the sensor axis to the measuring axis whereby the carrier substrate with the sensor configuration and hence the sensor axis is rotated by a distance b relative to the measuring axis in the measuring direction. The drawing shows the carrier substrate 2′ in this position together with the sensor axis produced by sensors S1′ and S2′. As the scales are configured to be relatively wide compared to the required measuring track, which is due to the minimum adhesive area as well as for example the small Hall elements having a small sensor area of 200 μm×200 μm, rotating the sensor axis is the preferred method at least for sensor configurations having Hall sensors. Assuming the pole division PT is 1 mm and the scale width is for example greater than 3 mm it is obvious that it is possible to rotate the sensor axis with the carrier substrate up to 90° relative to the measuring axis in the measuring direction and infinitely adjust the projected effective sensor distance in the measuring device from practically 0 up to a distance of T (n+½±¼). In addition, rotating the sensor axis in the plane parallel to the surface of the scale guarantees a homogeneous and constant magnetic induction with respect to the angle or path that is beneficial to the evaluation.

FIG. 5 shows the relationships of the sensor axis with the measuring axis in the measuring direction for the displacement by tilt and rotation as well as the projection of the effective sensor distances including the combination of both changes in position. In the starting position the sensor axis S1 to S2 follows the path of the measuring axis in the measuring direction. The effective sensor distance S is identical to the distance between the sensors. The sensor axis is tilted by height h about the point of sensor S1 so that S1 coincides with S1′ and S2′ produces the projected distance S′=\sqrt{S²−h²}. If the sensor axis is now rotated from the starting position with the projected distance S′, S1″ coincides with S1′ (S1) and S2″ gives the projected effective distance S″=\sqrt{S²−h²−b²}.

By displacing the sensor axis from the measuring axis according to the invention a wide variety of different incremental measuring divisions can be aligned, allowing precise signal sequences of sine/cos signals required for extremely high resolution angular and linear encoders to be achieved. The alignments can be made for example in the factory of the manufacturer during production of the encoder, when they are commissioned in the field, during a test run at the customer and when carrying out servicing, if the relevant precautions are taken in configuring and constructing the encoder to allow displacement of the sensor axis to the measuring axis in the measuring direction. The encoder 1 itself may be tilted and/or rotated from the measuring axis when it is attached or the carrier substrate 2 holding the sensor configurations with at least two sensors S1, S2 may be tilted and/or rotated directly or indirectly within or relative to the encoder.

The adjustments according to the invention not only provide a cost-effective method of simplifying the alignment process during production of the encoder and scale components with respect to their incremental divisions, they also enable angle and linear measuring systems to be adapted to various conditions of integration and operation in order to achieve the greatest possible accuracy. In addition there is the particular advantage that a standard encoder with a fixed sensor configuration and the distance between the sensors may be used for a large number of scale configurations having smaller/equal incremental divisions (MT, PT) with T (n+½±¼). The adjustment according to the invention also has the advantage of complementing the otherwise still dynamic phase compensation of the signal sequences undertaken electronically by the signal and measured value processor, which arises due to tolerances between the production of one incremental division and another e.g. through magnetizing or in the scale or the interaction of scale/measuring disk and encoder during operation.

The process according to the invention as well as the configurations for displacing the sensor axis relative to the measuring axis are also applicable to other physical principles of measurement such as e.g. optical, inductive, capacitive etc. and shall be expressly included with the magnetic angle and linear encoders discussed.

This application claims the priority, under 35 U.S.C. § 119, of German patent application No. 103 22 130.1, filed May 15, 2003; the entire disclosure of the prior application is herewith incorporated by reference.

I claim:

1. An encoder, comprising:
a measuring unit having incremental scale divisions; and
at least one sensor configuration having at least two sensors displaced in a measuring direction and providing signals relating to a path traveled within a segment, and effective distances of said sensor configuration containing said sensors projected onto a measuring axis in the measuring direction being altered by displacing a sensor axis relative to the measuring axis.

2. The encoder according to claim 1, wherein the sensor axis is rotated relative to the measuring axis.

3. The encoder according to claim 1, wherein the sensor axis is tilted relative to the measuring axis.

4. The encoder according to claim 1, wherein the encoder containing said sensor configuration is one of rotated and tilted relative to the measuring direction.

5. The encoder according to claim 1, wherein said sensor configuration is one of rotated and tilted within the encoder.

6. The encoder according to claim 1, further comprising a carrier substrate, said sensors disposed on said carrier substrate and a distance between said at least two sensors on said carrier substrate is greater than or equal to T (n+½±¼), where T is an incremental measuring division and n a total number of the scale divisions in said measuring unit effectively covered by said sensors.

7. The encoder according to claim 1, wherein the encoder is selected from the group consisting of angular encoders and linear encoders.

8. A process for an encoder that evaluates incremental scale configurations using sensors displaced in a measuring direction, which comprises the step of:
displacing a sensor axis relative to a measuring axis.
